(19) United States
(12) Patent Application Publication
(10) Pub. No.: US 2007/0238407 A1
(43) Pub. Date: Oct. 11, 2007

(54) Side mounted cowl vents for an over-the-road tractor vehicle

(76) Inventors: Richard Nottke, Traverse City, MI (US); Bruce Flaska, Traverse City, MI (US)

Correspondence Address: DOUGLAS W RUDY;LAW OFFICES OF DOUGLAS W. RUDY, LLC, 401 N. MICHIGAN AVENUE, SUITE 1200, CHICAGO, IL, 60611, US

(21) Appl. No.: 11/726,016

(22) Filed: Mar. 20, 2007

Related U.S. Application Data
(60) Provisional application No. 60/785,211, filed on Mar. 22, 2006.

(51) Int. Cl. B60H 1/24

(52) U.S. Cl. 454/164

(57) ABSTRACT

A cowl vent for an over-the-road tractor that assists in the evacuation of heated air from the engine bay and an increase in airflow through the engine bay of an over-the-road tractor. Vents are placed in the cowl zone of the truck cab generally below the A-pillar of the cab. The cowl vent is made up of a flange having a leading edge lip and a deflector mounted spaced apart from the lip to create a first port for the exhaust of heated engine bay air. A second port is formed by the deflector at a trailing area of the deflector and heated air will also exit out this second port as well as out the first port.

This application claims the benefit of Provisional Patent Application No. 60/785,211 filed Mar. 22, 2006 and further incorporates such application in its entirety.

### FIELD OF THE INVENTION

This invention addresses the use of side mounted cowl vents for use on over the road tractors used to haul semi-trailers.

### BACKGROUND OF THE INVENTION

In the current development of tractors for use in over the road trailer hauling duty the direction has been to increase tractor fuel efficiency by increasing engine efficiency. This entails running engines, typically diesel fueled engines, at elevated temperatures. With streamlining of tractors also being adopted by designers it has been the practice to enclose the engine compartments of over-the-rode tractors so that airflow through the engine bay can be controlled by engineered designs of tractor engine designers. Airflow management often entails designs where airflow is directed to flow through the radiator through the engine bay and then out the bottom of the engine bay. This leaves a clean line on the engine bay side panels for good aerodynamic flow. It also means that engine bay temperatures can be very high relative to where engine bay temperatures were several years ago.

In the engine bay of over-the-rode tractors there is significant plumbing, wiring, and various plastic enclosures and functional elements. The materials used for this equipment, the rubber compounds, the plastics and the wire shielding, is temperature resistant and heat degradation tolerant in conventional environments, such as those not exposed to the elevated engine bay temperatures of contemporary over-the-road tractors but will break down in the intense heat now produced and trapped in some engine bays. The rubber components and plastic materials will last for a year or two however in a short period of time after that the various hoses, ductwork, wires, belts and plastic “bits” will fail due to cracking or other component failure on a regular basis much earlier than has been experienced to date.

### SUMMARY OF THE INVENTION

This invention presented here is a cowl vent that can be retrofitted to an existing over-the-road tractor. In an installed embodiment the invention comprises a set of cowl vents that assist in the evacuation of heated air from the engine bay of an over-the-road tractor. The vents are placed in the cowl zone of the truck cab generally below the A-pillar of the cab. Many engine bays have a firewall as the rear wall enclosure of the engine bay. One location of the cowl vents is just forward of the firewall in a section of the engine bay that is generally below the tractor's A-pillar.

The cowl vent is made up of several components and is engineered to be installed in the side cowl area of an existing vehicle or to be integral with the side cowl component of a tractor vehicle when it is manufactured.

In one embodiment of the invention an apparatus for use in venting an engine bay of a vehicle, such as an over-the-road tractor used for hauling a trailer is provided. The vent will include a flange having an upstanding lip partially surrounding a rectangular opening in the flange. A deflector is carried in the rectangular opening of the flange. There will be a first port formed between the upstanding lip of the flange and the deflector. A second port is formed between the trailing edge of the deflector and a trailing portion of the flange that is devoid of the upstanding lip of a leading and horizontal portions of the flange.

The vent is used in assisting the evacuation of heated air from the engine bay of a tractor. It is also desirable to increase the volume and magnitude of airflow through an engine bay. By increasing the volume of air that passes through the engine bay the flow of air that passes through the vehicle's primary air-to-liquid radiator, various oil coolers and turbocharger precoolers, to the extent such devices are mounted in the engine bay, will increase. Thus the radiators and coolers, as well as the engine itself and engine bay mounted hardware will remain somewhat cooler and operate more efficiently. By bringing down the heat level in an engine bay it is expected that hoses, electrical wiring, belts and plastic components will have an improved useful life resulting in fewer road breakdowns and extended replacement intervals.

The vent locations, in one embodiment, in the side cowl location below the vehicles A-pillar, will assist in establishing a flow pattern of air through the engine bay that will minimize localized trapped air pockets or stagnant air zones. Not only does increasing air flow through these pockets help cool these localized hot zone areas but increased air flow may also improve overall airflow through the engine bay.

To increase the flow of air through an engine bay of an over-the-road tractor vehicle the process will include the acts of forming an opening in the side cowl of the tractor, providing a vent having a first port and a second port, and locating the vent over the opening formed in the side cowl of the tractor. The vent will be fixedly attached to side cowl location of the tractor by fasteners such as, but not limited to screws, nut and bolt fasteners, or by having the vent bonded to the cowl panels.

It is an object of this invention to provide a vent system that will allow the escape of heated air from an engine bay of a truck.

It is also an object of the invention to increase airflow through the engine bay of a truck to cause more air to flow through the vehicles radiator and other heat exchangers.

Another object of the invention is to eradicate localized hot spots in an engine bay by providing better airflow from the front of the engine bay to the firewall of the engine bay.

It is another object of the invention to provide an aftermarket vent product that can be sold as an accessory for retrofitting to trucks to improve engine bay circulation.

It is another object of this invention to provide a vent system that will increase the life expectancy of polymer-based components in an engine bay of a truck.

It is a further object of the invention to provide a vent in the side of a truck that is capable of evacuating the engine bay of the truck using passive airflow inducement elements.

It is also an object of the invention to provide a vent system that is mounted in a zone of the cab of a truck to minimize the collection of debris in the vent system.

It is another object of the invention to provide a vent for a truck that improves the looks of the truck.

It is also an object of the invention to provide a vent system that assists in cooling the driver's compartment of a truck by venting heated air from in front of the trucks firewall.

It is a further object of the invention to provide a vent system that can augment currently installed vent system provided from the truck manufacturer to decrease engine bay heat buildup.

The preferred embodiments of the invention presented here are described below in the specification and shown in the drawing figures. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning. In particular, most words have a generic meaning. If it is intended to limit or otherwise narrow the generic meaning, specific descriptive adjectives will be used to do so. Absent the use of special adjectives, it is intended that the terms in this specification and claims be given their broadest possible, generic meaning.

Likewise, the use of the words “function,” “means,” or “step” in the specification or claims is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically recite the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

### BRIEF DESCRIPTION OF THE FIGURES

FIG. 1 is a side view of a tractor showing a vent positioned on the side cowl area of the tractor.

FIG. 2 is a side elevation view of the vent.

FIG. 3 is a cross sectional view of the vent of FIG. 1 through plane 3-3.

FIG. 4 is a top view of the vent of FIG. 2.

FIG. 5 is a top view of the vent showing airflow around and through the vent.

### DESCRIPTION OF THE INVENTION

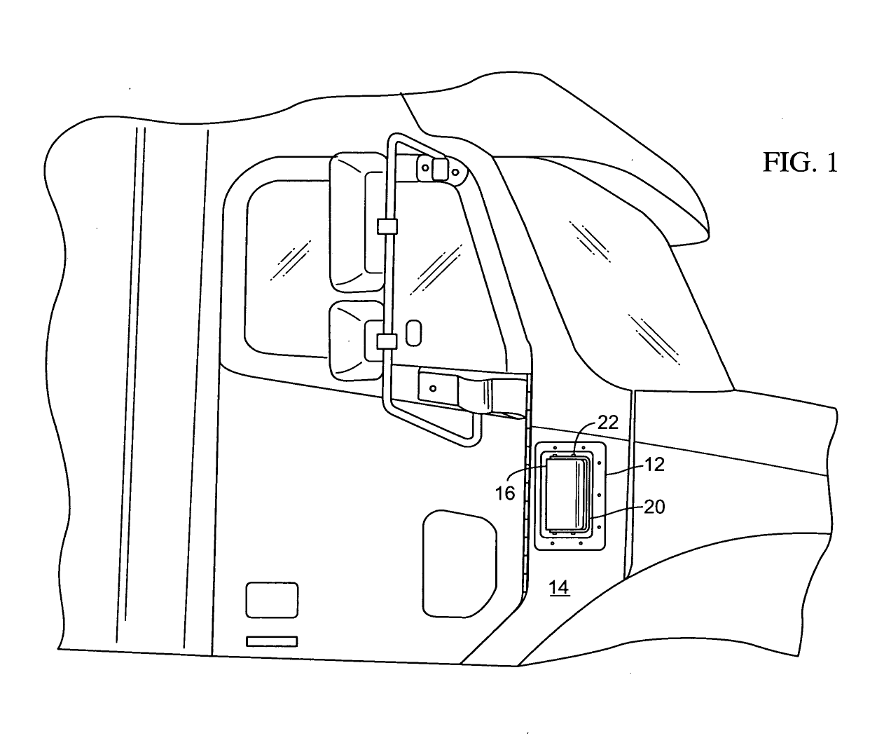

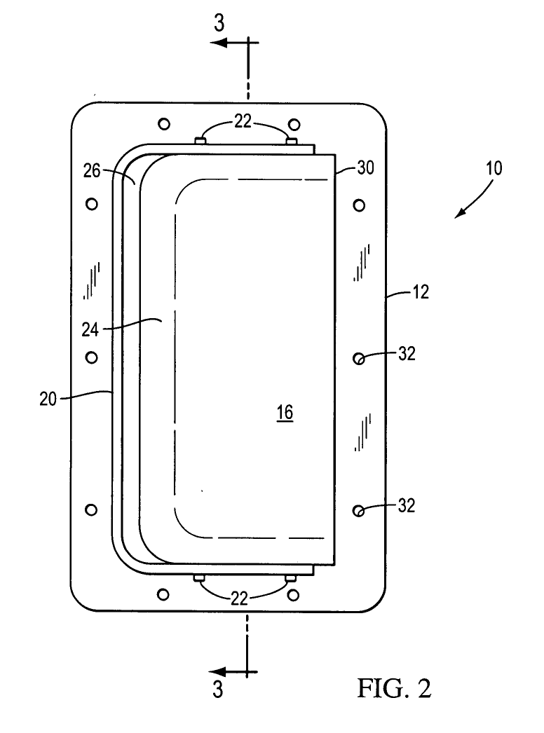

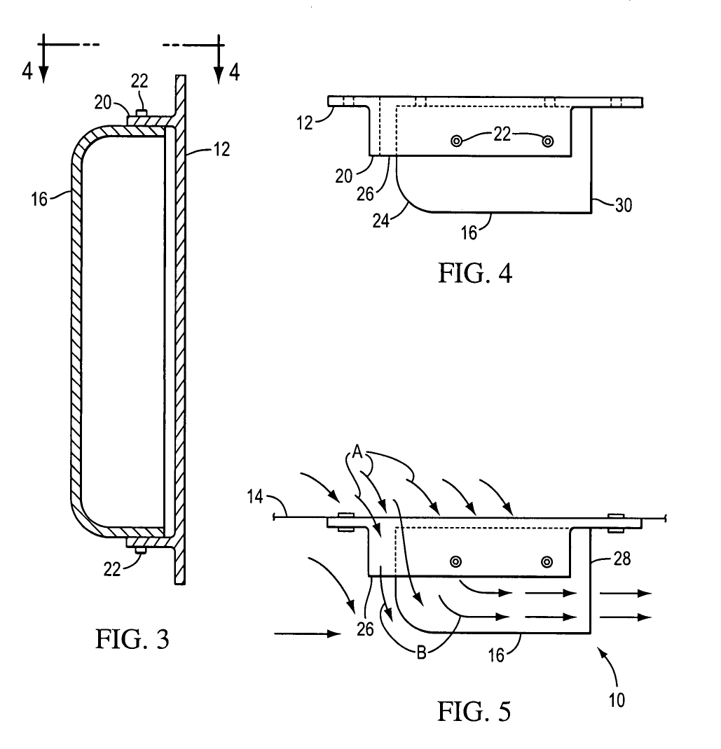

As seen in each of the figures the vent, generally 10 as shown is constructed of plastic, fiberglass, metal, carbon fiber, or other material that will provide a stiff and durable product. In one embodiment it is made up of a surround flange 12 that will be attached to a panel, such as the side cowl, 14 in FIG. 1 of a truck. Fastening and securing of the vent to the side cowl can be by any suitable fastener such as screw fasteners, nut and bolt fasteners, rivets, or adhesives. It can be “glassed in” using fiberglass as is well know in the trade.

The vent 10 may include a deflector element 16 that is carried in the surround flange 12. In one embodiment the deflector element 16 fits inside a raised lip 20 or wall of the surround flange 12 and is secured in that location by fasteners 22.

The deflector element 16 has a curved leading portion 24 that would face the front of the host truck. The curved leading portion 24 may be spaced rearwardly from the raised lip 20 of the surround flange 12 and provide an opening 26 between the curved portion 24 and the raised lip 20. The trailing edge 30 of the deflector element 16 defines an open area generally the height of the deflector element 16 and provides a passage whereby air can exit the cowl area and the engine bay behind the cowl area of the tractor.

In FIG. 4 the trailing edge 30 of the deflector element is shown extending from the top to the bottom of the deflector element. Also seen in this figure is that the raised lip 20 portion of the surround flange 12 does not extend from the bottom of the flange to the top of the surround flange at the rear are of the flange element as it does at the front of the surround flange but is nonexistent at the rear of the surround flange.

It is contemplated that a screen can be positioned inboard of the deflector element to prevent the passage of larger objects from getting into or coming through the vent.

As can be seen there are two passages formed by the vent. One passage, the opening 26 between the lip 20 and the curved portion 24 of the deflector element and a second airflow passage is formed at the trailing end of the deflector element. In the front area or leading portion of the vent the raised lip 20 of the surround flange 12 will serve as an air dam and create a low pressure area downstream of the raised lip which is toward the back side of the raised lip. This low-pressure area behind the raised lip at the front of the vent will aid in inducing airflow through the vent.

It is believed that having these two passages for airflow through the vent improves vent performance and will assist in evacuating heated air from an engine bay of an over-the-road tractor. The placement of the vents in the side cowl area will help move heated air from the top and rear area of an engine bay where heated air may normally be somewhat trapped as it would have no escape route from the engine bay. For instance, even in the embodiment of FIG. 1 where air may escape from the opening between the hood and the cowl air rearward of this opening may be stagnant or slow moving thus letting heat build up in this area.

The vent is designed to be mounted as shown in FIG. 1 with the opening of the deflector element facing away from the normal direction of travel of the truck. In this location it is believed that airflow through the engine bay will be improved with the effect of eliminating localized hot spots. By improving airflow through the engine bay, flow through the vehicle's radiator and other heat exchangers mounted in the engine bay will be improved as well as providing general cooling of the engine bay through increased airflow resulting from vent locations in the side cowl below the a-pillar.

FIG. 5 shows airflow, represented by arrows passing into, through and out of the vent. Arrows, such as but not limited to, “A” at the top of the figure represent heated air on the engine bay side of the side cowl 14. The vent generally 10 includes an air access port 26, the opening between the lip and the curved portion of the deflector 16 and a second air access port 28 formed between the deflector and a portion of the flange where the upstanding lip is not surround the opening in the vent. That is, the lip does not extend to the trailing edge of the opening of the vent. The lip only extends along three sides of the opening, that is the leading edge and the top and bottom edges of the opening. Arrows, such as but not limited to “B,” show airflow through and out of the vent. This will be the air exhausted from the engine bay and delivered outside the engine bay as the truck goes down the road.

The figures show the preferred location of one vent on one type of tractor. In a usual situation there will be one vent on each side of the engine compartment in the cowl area of the host truck, thus two vents on each truck body. The vents 10 are in the side cowl area 14 behind the rear hood line and in front of the door of the tractor. This area will be at the rear area of the engine bay and in front of the firewall of the tractor. As noted in FIG. 1 there is no vent system provided in the hood area covering the engine bay of the pictured vehicle. In the embodiment shown air may escape from the margin where the hood meets the cowl.

In another embodiment of the invention the vent 10 can be positioned in the location as shown but “plumbed” to allow the evacuation of air from behind a firewall or from a zone between a first firewall and a second firewall.

Obviously if the vent is to evacuate air from the engine bay there will need to be air passage through the sheet material of the tractor cab. Such an aperture, hole, or air passage is cut into the cowl area before the vent is mounted in place. An internal duct may be fabricated and connected to the vent. In one embodiment holes are cut in the cowl side locations and the vents are installed as shown in FIG. 1.

This vent can be a retrofitted to existing vehicles or can be incorporated in new vehicles as they are being manufactured. In retrofitting a vent 10 a vent location on the cowl will be selected and an opening through the side cowl made. The new vent 10 will be mounted over the opening and fastened using fasteners through the holes such as 32 to the side cowl of the vehicle.

In summary the inventors have provided an air evacuation vent that includes a structure having a flange surrounding a rectangular opening in the vent. The flange has an upstanding lip partially surrounding the opening in the vent. A deflector is carried in the opening in the vent and the position of the deflector is such to form an air access port between the upstanding lip of the flange and the deflector. A second air access port is formed between the deflector and a portion of the flange where the upstanding lip is not surrounding the opening in the vent. The flange of the vent has a leading portion and a trailing portion and the rectangular opening in the vent has a leading edge, a trailing edge, a top edge and a bottom edge surrounding the opening in the flange. The upstanding lip is located on the leading portion of the flange near the leading edge of the rectangular opening of the vent and the lip extends along the top edge and the bottom edge of the rectangular opening in the flange.

The deflector of the vent, attached to the upstanding lip at the top edge and at the bottom edge of the rectangular opening in the flange, has a leading portion and a trailing portion and a contoured convex surface at the leading portion of the deflector. The deflector also has an open portion at the trailing portion of the deflector.

The deflector is attached to the upstanding lip such that the deflector is spaced away from the upstanding lip at the leading portion of the flange whereby an air access port is formed between the upstanding lip of the flange and the deflector. This forms a low-pressure area adjacent the upstanding lip near the leading edge of the rectangular opening of the vent when the truck is driven and there is significant air flow over the vent and the side cowl area on each side of the truck.

The method for assisting in evacuating heated air from the engine bay of a tractor includes the acts of forming an opening in the side cowl of the tractor, providing a vent having a first port and a second port, and locating the vent over the opening formed in the side cowl of the tractor. This evacuation of heated air from the engine bay will entail causing the flow of air over the upstanding lip of the flange and forming a low pressure area at the air access port by the flow of air over the upstanding lip of the flange as well as forcing heated air from the engine bay of a tractor through the vent in the side cowl of the tractor.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claim.

What is claimed is:

1. An air evacuation vent comprising:
a flange surrounding a rectangular opening in the vent, the flange having an upstanding lip partially surrounding the opening in the vent;
a deflector carried in the opening in the vent;
an air access port formed between the upstanding lip of the flange and the deflector;
a second air access port formed between the deflector and a portion of the flange where the upstanding lip is not surrounding the opening in the vent.

2. The invention in accordance with claim 1 wherein the air evacuation vent is mounted in a side cowl location of an over-the-road tractor vehicle.

3. The invention in accordance with claim 2 wherein the side cowl location is below the A-pillar of the vehicle.

4. The invention in accordance with claim 1 further comprising:
the flange having a leading portion and a trailing portion;
the rectangular opening in the vent having a leading edge, a trailing edge, a top edge and a bottom edge surrounding the opening in the flange; and
the upstanding lip is located on the leading portion of the flange near the leading edge of the rectangular opening of the vent.

5. The invention in accordance with claim 4 wherein the upstanding lip extends along the top edge and the bottom edge of the rectangular opening in the flange.

6. The invention in accordance with claim 1 wherein the deflector comprises:
the deflector having a leading portion and a trailing portion;
a contoured convex surface at the leading portion thereof; and
an open portion at the trailing portion of the deflector.

7. The invention in accordance with claim 1 wherein the deflector is attached to the upstanding lip of the flange.

8. The invention in accordance with claim 5 wherein the deflector is attached to the upstanding lip at the top edge and at the bottom edge of the rectangular opening in the flange.

9. The invention in accordance with claim 7 wherein the deflector is attached to the upstanding lip such that the deflector is spaced away from the upstanding lip at the leading portion of the flange whereby the air access port is formed between the upstanding lip of the flange and the deflector.

10. The invention in accordance with claim 1 wherein the air access port formed between the upstanding lip of the flange and the deflector comprises a low-pressure area adjacent the upstanding lip near the leading edge of the rectangular opening of the vent.

11. An air evacuation vent comprising:
a flange, having a leading portion and a trailing portion, the flange surrounding a rectangular opening in the vent, the vent having a leading edge, a trailing edge, a top edge and a bottom edge surrounding the opening in the flange;
an upstanding lip located on the leading portion of the flange near the leading edge of the rectangular opening of the vent and partially surrounding the opening in the vent;
a deflector having a leading portion and a trailing portion and a contoured convex surface at the leading portion thereof, the deflector carried in the opening in the vent;
an air access port formed between the upstanding lip of the flange and the deflector;
a second air access port formed between the deflector and a portion of the flange where the upstanding lip is not surrounding the opening in the vent.

12. The invention in accordance with claim 11 wherein the upstanding lip extends along the top edge and the bottom edge of the rectangular opening in the flange.

13. The invention in accordance with claim 11 wherein the deflector comprises an open portion at the trailing portion of the deflector.

14. The invention in accordance with claim 11 wherein the deflector is attached to the upstanding lip at the top edge and at the bottom edge of the rectangular opening in the flange.

15. The invention in accordance with claim 11 wherein the air evacuation vent is mounted in a side cowl location of an over-the-road tractor vehicle below the A-pillar of the vehicle.

16. A method for assisting in evacuating heated air from the engine bay of a tractor comprising:
forming an opening in the side cowl of the tractor;
providing a vent having a first port and a second port;
locating the vent over the opening formed in the side cowl of the tractor.

17. The method in accordance with claim 16 wherein the vent comprises:
a flange surrounding a rectangular opening in the vent, the flange having an upstanding lip partially surrounding the opening in the vent;
a deflector carried in the opening in the vent;
an air access port formed between the upstanding lip of the flange and the deflector;
a second air access port formed between the deflector and a portion of the flange where the upstanding lip is not surrounding the opening in the vent.

18. The method in accordance with claim 17 comprising;
causing the flow of air over the upstanding lip of the flange; and
forming a low pressure area at the air access port by the flow of air over the upstanding lip of the flange.

19. The invention in accordance with claim 15 comprising forcing heated air from the engine bay of a tractor through the vent in the side cowl of the tractor.

20. The invention in accordance with claim 19 comprising increasing air flow from the front of an engine bay of an over-the-road tractor vehicle to the firewall of the vehicle whereby localized areas of stagnate air in the engine bay are subjected to airflow due to the placement of a vent in the side cowl of the tractor.
